(19) United States
(12) Patent Application Publication
(10) Pub. No.: US 2006/0252455 A1
(43) Pub. Date: Nov. 9, 2006

(54) Multimedia communication device to capture and insert a multimedia sample

(75) Inventors: Leonardus Cornelis Antonius Van Stuivenberg, Eindhoven (NL); Bartel Marinus Van De Sluis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/554,035

(22) PCT Filed: Apr. 23, 2004
(86) PCT No.: PCT/IB04/50499

§ 371 Date: Oct. 20, 2005

(30) Foreign Application Priority Data
Apr. 24, 2003 (EP) 03101142.2

(51) Int. Cl. H04M 1/00

(52) U.S. Cl. 455/556.1; 455/552.1

(57) ABSTRACT

A device (100) for multimedia communication is equipped with control means (110). In response to a single activation (130) of the control means (110), the device (100) takes a sample (133) of some multimedia content (136), adds the sample (133) to a message (134) being processed (122) and optionally dispatches (135) the message (134) with the attached sample (133) to a recipient. This makes it easier for a receiver of the dispatched message (135) to identify and authenticate the author of the message (134). It is also easier, when processing the message (134), to express the mood of the author of the message (134) and to convey the current situation and surroundings of the author. When the dispatched message (135) contains a command for controlling a communication session, the fresh sample (133) can be reproduced at the recipient, elucidating the command. Examples include a hello or farewell greeting from the sender of the message (135). The dispatched message (135) may contain an invitation to a communication session, preventing the hassle of obtaining, storing and maintaining samples locally, for example, for caller identification and making it easier for the recipient to decide upon participation in the session.

The invention relates to a device for multimedia communication, comprising capture means for capturing a sample of multimedia content and processing means for processing a message.

The invention also relates to a method for multimedia communication, the method comprising the steps of capturing a sample of multimedia content and processing a message.

A device as described in the opening paragraph is known from the Sony Ericson P800 mobile phone as described in its User's Guide, First Edition (November 2002), issued by Sony Ericsson Mobile Communications AB, publication number EN/LZT 108 6040 R1A. Many mobile phones nowadays come with the ability to take pictures, in addition to the ability of sending Multimedia Message Service (MMS) messages. So-called emoticons like the smiley [symbol] can be inserted in the text of a message to express the authors' mood. Inserting emoticons is relatively simple. Using a camera, a sample or snapshot like a photograph or still image may be included in a message for the same purpose of expressing the author's mood. With a sample included, it can also become much easier for a receiver of the message to identify and authenticate its author. Moreover, a sample also easily conveys the current situation of the author, thus providing a framework for interpreting the message. Sending a message with an included sample, however, involves the steps of taking the sample, storing the sample, including the sample in the message by editing the message and selecting the stored sample. Finally, the message can be dispatched. Most of these steps require the user to repeatedly operate the device manually. This increases the possibilities of making accidental or intended errors, which deteriorates the value of the sample for authentication purposes. It also causes the sending of such messages with the device to be laborious and complicated for the user.

It is an object of the present invention to provide a device for multimedia communication of the kind described in the opening paragraph that does not suffer from the above-mentioned drawbacks.

This object is realized in that the device comprises control means for controlling the capture means and the processing means, such that the sample is captured and added to the message in response to a single activation of the control means. Due to the single activation, capturing and adding become an indivisible action, making it more difficult to tamper with the sample. The single activation also saves the separate steps of operating the device for capturing, storing, retrieving and inserting the sample.

Advantageously, the device further comprises dispatching means for dispatching the message with the sample added in response to the single activation. This saves another additional manual step in operating the device and further limits the possibilities of tampering with the dispatched message.

Advantageously, the capture means comprise a camera, and the sample comprises a photo. In order to capture the mood of the author, a photo taken with a camera has the additional benefit of easily exploiting facial expressions. Another advantage is that the photo can also easily convey the actual context of the author for interpreting the message.

Advantageously, the device comprises a mobile phone. This has the advantage of an easy switch to a more interactive voice call in response to receiving a message. Alternatively, a message with a sample can easily be sent to the other party during a voice call or during some other communication session.

Advantageously, the message comprises a command for controlling a communication session. This has the advantage that the sample can provide additional information pertaining to the sender of the message or to the session. Also there is no risk of out-of-date or unfashionable samples. It may be useful, for example, to show a picture of a participant leaving the session, especially if there are many participants in the session. The sample may also be used during the session, for example, as a reminder of the participants in the session, or to identify a participant to the other participants.

Advantageously, the message comprises an invitation for a communication session. This has the advantage that it prevents the hassle of creating, storing and maintaining entries in an address book at the destination for a so-called multimedia caller identification service. With this service, the sample is reproduced at the destination upon reception, simplifying the recognition of the inviting party. One example is showing a thumbnail picture of the caller with an incoming call. Another example is an audio sample with the name of the caller, or a short clip introducing the topic of the session. A device according to the invention makes picture caller identification possible without any prior contact between the sender and the receiver. Moreover, the sample can give additional and actual information on the intention of the session or its context, making it easier for the recipient to decide on participation. Furthermore, the sample may persuade the recipient to participate in the session.

In an embodiment of the method for multimedia communication according to the invention, the method comprises the steps of:
capturing a sample of a multimedia content,
processing a message, and
activating a single control for capturing the sample and adding the sample to the message. This method reduces the possibilities of tampering with the sample, and saves a few steps in operating the device for capturing, storing, retrieving and inserting the sample.

Advantageously, activating the single control also dispatches the message, further reducing the possibilities of tampering with the message, and saving another additional manual step in operating the device.

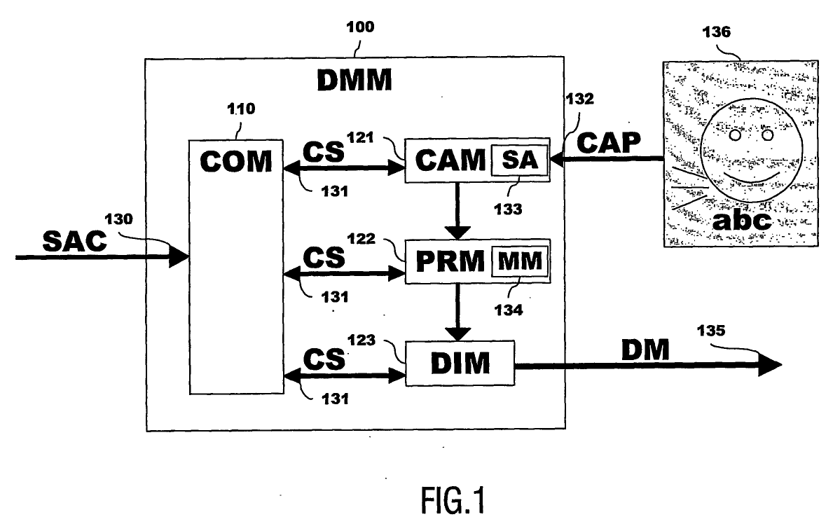

The above object and features of the present invention will be more apparent from the following description of the preferred embodiments with reference to the drawing wherein FIG. 1 is a block diagram of an embodiment of a device according to the invention.

Some of the features indicated in the drawing may be implemented in software, and as such represent software entities, such as software modules or objects.

FIG. 1 is a block diagram of an embodiment of a device 100 according to the invention.

The device 100 for multimedia communication comprises control means 110, capture means 121 and processing means 122. Optionally, the device 100 comprises dispatching means 123. The device 100 may be distributed, comprising separate physical parts that are connected to perform its functions as a whole. An example of this is a device 100 that comprises a mobile phone and a so-called snap-on camera that can be snapped onto the phone. Another example is a so-called personal digital assistant (PDA) or a desktop or palmtop personal computer (PC) that communicates wirelessly with a separate multimedia recorder, for example, based on the so-called BlueTooth standard. Thus, the device 100 covers a single logical entity rather than a single physical entity. The device 100 may also be a multimedia terminal, which may be mobile, portable, handheld or fixed and wireless or wired. Also, the device 100 may comprise a general-purpose hardware platform provided with means or instructions, which provide the functionality of a multimedia terminal.

Using control signals 131, the control means 110 control the capture means 121, the processing means 122, and the dispatching means 123. In response to a single activation 130 of the control means 110, the control means 110 ensure that a sample is captured and added to a message 134 and that, optionally, the message 134 is dispatched 135.

The message 134 may be, for example, a short message service (SMS) message, or a multimedia message (MMS) or an electronic mail message, or a message in general as used with instant messaging or chatting or as used with unified messaging or multimedia communication.

The capture means 121 can capture a sample 133 of a multimedia content 136. Capturing the multimedia content 136 may comprise capturing several components. One component may be a still image or snapshot. Another example of a component is a series of images or a series of images with such a frequency that a short movie or clip is captured. Another component is audio, for example, an audio sample of a few seconds or a stereophonic audio sample. Another example is a voice message or voicemail. Also capturing a color can result in a component, or capturing a bar code. Other components include temperature and smell. Yet another component may be tactile information as derived from a hand grip or sensed with a glove. All of the above examples are easily extended to include further components and are, therefore, not intended to limit the components in either way. Also combinations of components can be made. One example is a combination of video and audio components to obtain an audiovisual sample as is normally reproduced in a television set. Capturing is initiated by the control signals 131 from the control means 110, in response to the single activation 130. After capturing, the sample 133 is forwarded to the processing means 122. To alert to the user that capturing is in progress, the device 100 may comprise visual or audible indicating means (not shown). Examples include a light-emitting diode (LED) that emits light as long as capturing is in progress, and a speaker that mimics the “fladack” sound of a mirror-reflex camera. Another example is an indicator like a bar, indicating the progress while capturing a sample or clip with a fixed duration.

The processing means 122 serve the purposes of creating, composing and/or editing a message 134. The processing means 122 may provide the end-user (not shown) with the tools (not shown) for inserting text or other objects into a message 134. This typically comprises hardware and software providing an editing environment, like those known from text processors. The content of the message 134 is modified at a spot usually indicated by a cursor (not shown). In response to the control signals 131 from the control means 110, the processing means 122 insert the sample 133 with all its captured components as received from the capturing means 121, at the cursor without further user intervention. When done processing, the message 134 is optionally forwarded to the dispatching means 123.

If a message 134 was not already being processed upon the single activation 130, the control means 110 may also cause the message 134 to be created by the process means 122.

The dispatching means 123 allow dispatching of the processed message 134. This causes a message 135 to be dispatched from the device 100, on either a wired or wireless medium (not shown) towards a recipient (not shown) of the message or to an intermediate station (not shown). The message 134 received from the processing means is dispatched in response to the control signals 131 from the control means.

What happens in effect is that, upon activating the control means 110, a sample 133 is captured 132, the sample 133 is added to the message 134, and the message 134 is optionally dispatched 135.

The control means 110 may comprise a physical button (not shown) on the device 100. Alternatively, a so-called soft button can be rendered on a display screen (not shown). The soft button is activated by clicking it with a mouse or tapping a touch-sensitive screen with a stylus or with a finger in its proximity. The control means 110 may be arranged to dispatch the message upon activation to a recipient that is represented on the display screen. Especially, the control means 110 may be arranged to dispatch the message upon activation to one or more selected recipients that are part of a list shown on the display screen. Selecting the recipients can be based on the way the recipients are listed, like highlighted or colored differently. Selecting the recipients can also be based on the distance between the displayed recipient and the spot of clicking, such that the closest recipient is selected. Recipients can also be selected from the parties currently engaged in communication sessions of the device 100, like voice calls or chat sessions.

Received samples can be stored and subsequently used at the receiving device. One example of using such a stored sample is that it serves as a reminder for the participants of the session. Another example is identification of one particular participant to all participants, or, for example, identifying the chair of the session to enhance so-called floor control mechanisms.

The message 134 may comprise a command (not shown) for controlling a communication session (not shown). The recipient of the dispatched message 135 is requested to apply the command to the communication session. In response to receiving the message, the sample 133 can then be reproduced at the receiving device (not shown) as part of handling the received message 135. An example of a command is to accept or reject an invitation to the session, terminate the session, or remove the sender as a participant of the session or change some other parameters of the session, like streaming details as ports, addresses, packet routing, encoding, decoding, buffering, protocols, flow control, etc. The sample 133 can identify, for example, a person entering or leaving the session, or a fresh hello or farewell greeting from that person.

The message 134 may also comprise an invitation (not shown) for a communication session (not shown). The recipient of the dispatched message 135 is invited to engage in the communication session. In response to receiving the message, the sample 133 can then be reproduced at the receiving device (not shown) as part of handling the received message 135. The reproduced sample can make it easier for the recipient to decide about accepting or rejecting the invitation, and, as a result, to decide upon participation in the communication session. The sample may also describe the sender or the session. Examples include the topic of the session, its setting or context, the current situation of the sender in relation to the session, etc. Presenting the sample may be more descriptive to the recipient than presenting, for example, a telephone number, a nickname or a user identifier. Also, the sample may persuade the recipient to participate. If the recipient accepts the invitation, the recipient is added to the participants of the session. If required, the session can be created in response to accepting the invitation by either the receiving or the sending device.

Alternatives are possible. In the description above, use of the verb “comprise” and its conjugations does not exclude other elements or steps, and use of the indefinite article “a” or “an” does not exclude a plurality of such elements or steps, while a single processor or other unit may also fulfill the functions of several means recited in the claims.

1. A device (100) for multimedia communication, comprising:
capture means (121) for capturing a sample (133) of a multimedia content (136);
processing means (122) for processing a message (134); and
control means (110) for controlling the capture means (121) and the processing means (122), such that the sample (133) is captured and added to the message (134) in response to a single activation (130) of the control means (110).

2. A device (100) as claimed in claim 1, wherein the device (100) further comprises
dispatching means (123) for dispatching the message (134) with the sample (133) added in response to the single activation (130).

3. A device (100) as claimed in claim 1, wherein the capture means (121) comprise a camera, and the sample (133) comprises a photo.

4. A device (100) as claimed in claim 1, wherein the device (100) comprises a mobile phone.

5. A device (100) as claimed in claim 2, wherein the message (134) comprises a command for controlling a communication session.

6. A device (100) as claimed in claim 2, wherein the message (134) comprises an invitation for a communication session.

7. A method for multimedia communication, comprising the steps of:
capturing (132) a sample (133) of a multimedia content (136);
processing a message (134); and
activating (130) a single control (110) for capturing (132) the sample (133) and adding the sample (133) to the message (134).

8. A method for multimedia communication as claimed in claim 7, wherein the step of activating (130) the single control (110) also dispatches (135) the message (134).

9. A method as claimed in claim 8, wherein the message (134) comprises a command for controlling a communication session, the method further comprising the step of controlling the communication session in dependence upon the control command.

10. A method as claimed in claim 8, wherein the message (134) comprises an invitation for a communication session, the method further comprising the step of establishing the communication session in response to accepting the invitation.
